(19) United States
(12) Patent Application Publication
(10) Pub. No.: US 2002/0145987 A1
(43) Pub. Date: Oct. 10, 2002

(54) Wireless network architecture for GPRS over 30kHz channels

(76) Inventors: Hans Carlsson, Cary, NC (US); Patrik Laundqvist, Encinitas, CA (US)

Correspondence Address: HARRITY & SNYDER, LLP, 11240 WAPLES MILL ROAD, SUITE 300, FAIRFAX, VA, 22030, US

(21) Appl. No.: 09/828,864

(22) Filed: Apr. 10, 2001

(51) Int. Cl. H04L 12/66

(52) U.S. Cl. 370/329; 370/354

(57) ABSTRACT

A radio-communications system includes a mobile terminal, a first base station, and a second base station. The mobile terminal transmits first packets over a first radio-communications channel that has a first bandwidth, and transmits second packets over a second radio-communications channel that has a second bandwidth. The second radio-communications channel includes a circuit-switched control channel. The first base station receives and forwards the first packets, via a first path, to a packet-switched network. The second base station receives and forwards the second packets, via a second path, to the packet-switched network.

### BACKGROUND OF THE INVENTION

The present invention relates generally to wireless communications networks and, more particularly, to systems and methods for providing packet-data services in wireless communications networks.

Today's mobile communications users desire increasingly fast, more robust and more efficient wireless communication systems. Accordingly, manufacturers and standards bodies are continually improving current systems and implementing new standards to support additional capabilities. One such standard for providing data over both Global System for Mobile communications (GSM) and Time Division Multiple Access (TDMA)/136 systems is the Enhanced General Packet Radio Service (EGPRS).

An EGPRS-136 system integrates the TIA/EIA-136 circuit-switched air interface with the General Packet Radio Service (GPRS) as specified in GSM. More specifically, EGPRS-136 supports circuit-switched services on a 30 kHz air-interface as specified in TIA/EIA-136 and TIA/EIA-41 (ANSI-41) and packet data service on a 200 kHz air interface as specified in GSM. Thus, an EGPRS-136 mobile terminal may send and receive voice calls, as well as, send and receive e-mails, surf the web, etc.

### BRIEF SUMMARY OF THE INVENTION

In accordance with the purpose of the invention as embodied and broadly described herein, a method of implementing packet data service at a mobile terminal in a radio-communications network includes sending or receiving data packets via a first packet data service over a first radio-communications channel comprising a first bandwidth; and sending or receiving data packets via a second packet data service over a second radio-communications channel comprising a second bandwidth. The second radio-communications channel is a circuit-switched control channel.

In another implementation consistent with the present invention, a method of implementing packet data service at a mobile terminal in a radio-communications network includes determining a preference between a first packet data service and a second packet data service; determining, if the first packet data service is preferred, whether the first packet data service is available; attaching to the first packet data service if the first packet data service is available; and attaching to the second packet data service if the first packet data service is unavailable.

In a further implementation consistent with the present invention, a method of servicing packets in a radio-communication system includes receiving first packets over a first radio-communications channel comprising a first bandwidth; forwarding the first packets, via a first path, to a packet-switched network; receiving second packets over a second radio-communications channel comprising a second bandwidth; and forwarding the second packets, via a second path, to the packet-switched network. The second radio-communication channel includes a circuit-switched control channel.

In an additional implementation consistent with the present invention, a server includes a communication interface that receives packets transmitted from a mobile terminal using a packet-data service; and a processing unit that processes the received packets for transmission to a Serving General Packet Radio Service Serving Node (SGSN).

In another implementation consistent with the present invention, a radio-communications network includes a mobile terminal; a packet-switched network that selectively provides a 200 kHz packet data service to the mobile terminal; and a circuit-switched network that selectively provides, in conjunction with the packet-switched network, a 30 kHz packet data service to the mobile terminal.

In a further implementation consistent with the present invention, a method of providing packet data service to a mobile terminal in a radio-communications network includes providing a 30 kHz packet data service to the mobile terminal; and selectively providing a 200 kHz packet data service to the mobile terminal based on quality of service requirements of the mobile terminal.

### BRIEF DESCRIPTION OF THE DRAWINGS

The accompanying drawings, which are incorporated in and constitute a part of this specification, illustrate the invention and, together with the description, explain the invention. In the drawings,

FIG. 1 illustrates an exemplary network in which systems and methods, consistent with the present invention, may be implemented;

FIG. 2 illustrates a first portion of the exemplary network of FIG. 1;

FIG. 3 illustrates a second portion of the exemplary network of FIG. 1;

FIG. 4 illustrates an exemplary configuration of a mobile terminal consistent with the present invention;

FIG. 5 illustrates an exemplary configuration of a General User Datagram Protocol (UDP) Transport Service (GUTS)/General Packet Radio Service (GPRS) Internetworking Function (GGIWF) device consistent with the present invention;

FIG. 6 illustrates an exemplary protocol architecture for providing GUTS/GPRS packet-data service (GGPS) consistent with the present invention;

FIGS. 7-9 illustrate exemplary processes, consistent with the present invention, for attaching a mobile terminal to packet-data services; and

FIGS. 10-11 illustrate exemplary processes for receiving and processing messages at a GGIWF.

### DETAILED DESCRIPTION OF THE INVENTION

The following detailed description of the invention refers to the accompanying drawings. The same reference numbers in different drawings identify the same or similar elements. Also, the following detailed description does not limit the invention. Instead, the scope of the invention is defined by the appended claims and equivalents. For example, while the following description focuses on an EGPRS-136 200 kHz/TDMA 30 kHz environment, it will be appreciated that the present invention is equally applicable to other communication environments, such as a GPRS 200 kHz/TDMA 30 kHz environment.

Systems and methods, consistent with the present invention, may provide packet-data service in radio-communications cells where implementation of the 200 kHz bandwidth air interface of the EGPRS-136 (or GPRS) system would be impractical or too costly. To implement a conventional EGPRS-136 (or GPRS) system, additional hardware may be deployed at the cell base station to accommodate the higher 200 kHz bandwidth and to provide packet-data service. In some regions, however, these hardware modifications may not be justifiable economically. Systems and methods, consistent with the present invention, thus, may implement a new internetworking node between the circuit-switched network and a conventional GPRS network to permit packet data services using a 30 kHz bandwidth air interface and associated conventional base station hardware.

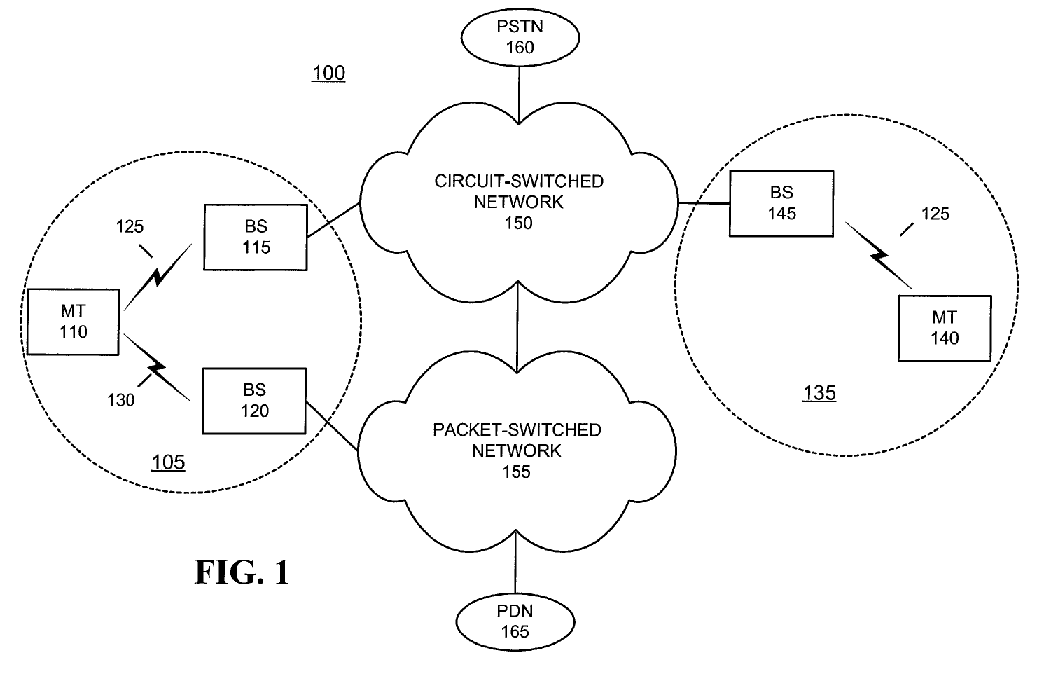

FIG. 1 illustrates an exemplary radio communications network 100 in which systems and methods, consistent with the present invention, may be implemented. Network 100 may include a mobile terminal (MT) 110 and base stations 115 and 120 associated with a first radio-communications cell 105. Network 100 may further include a mobile terminal 140 and a base station 145 associated with a second radio-communications cell 135. The first and second radio communication cells 105 and 135 may include the same radio-communications cells, overlapping radio-communication cells, or different radio-communication cells that are geographically contiguous. Network 100 may also include a circuit-switched network 150, a packet-switched network 155, a Public Switched Telephone Network (PSTN) 160, and a Public Data Network (PDN) 165.

Mobile terminals 110 and 140 allow users to interact with other devices via PDN 165 or PSTN 160. As described herein, mobile terminals 110 and 140 may include a radiotelephone with or without a multi-line display; a Personal Communications System (PCS) terminal that may combine a cellular radiotelephone with data processing, facsimile, and data communications capabilities; a Personal Digital Assistant (PDA) that can include a radiotelephone, pager, Internet/intranet access, Web browser, organizer, and/or calendar; and a conventional laptop and/or palmtop receiver or other appliance that includes a radiotelephone transceiver. Mobile terminals may also be referred to as “pervasive computing” devices.

Base stations 115, 120 and 145 allow other devices to communicate with mobile terminals 110 or 140. Base station 115 may provide mobile terminal 110 with circuit-switched services on an air interface 125 which may comprise, for example, a 30 kHz bandwidth air interface. Base station 120 may provide mobile terminal 110 with packet data services on air interface 130 which may comprise, for example, a 200 kHz bandwidth air interface. Voice or data may be transmitted across interfaces 125 and 130 in accordance with, for example, the EGPRS-136 (or GPRS) standard. Base station 145 may provide mobile terminal 140 with circuit-switched or packet-switched services on an air interface 125 which may comprise, for example, a 30 kHz bandwidth interface. Voice data may be transmitted across interface 125 in accordance with the TIA/EIA-136 or TIA/EIA-41 (ANSI-41) standards. Each base station 115, 120 and 145 may include one or more base transceiver stations (not shown) and a base station controller (not shown). The base transceiver stations may transmit radio signals to and receive radio signals from mobile terminals 110 and 140. Each base station controller may interconnect a number of base transceiver stations to the circuit-switched network 150 or packet-switched network 155.

Circuit-switched network 150 may include, for example, a network meeting the specifications of the ANSI-41 standard, such as TIA/EIA-136. Packet-switched network 155 may include, for example, a General Packet Radio Service (GPRS) network as specified in the Global System for Mobile Communications (GSM) standard. PSTN 160 may include the worldwide telephone network, consisting of wires and switches, that allows for connection of telephone calls. PDN 165 may include one or more conventional networks for routing data packets.

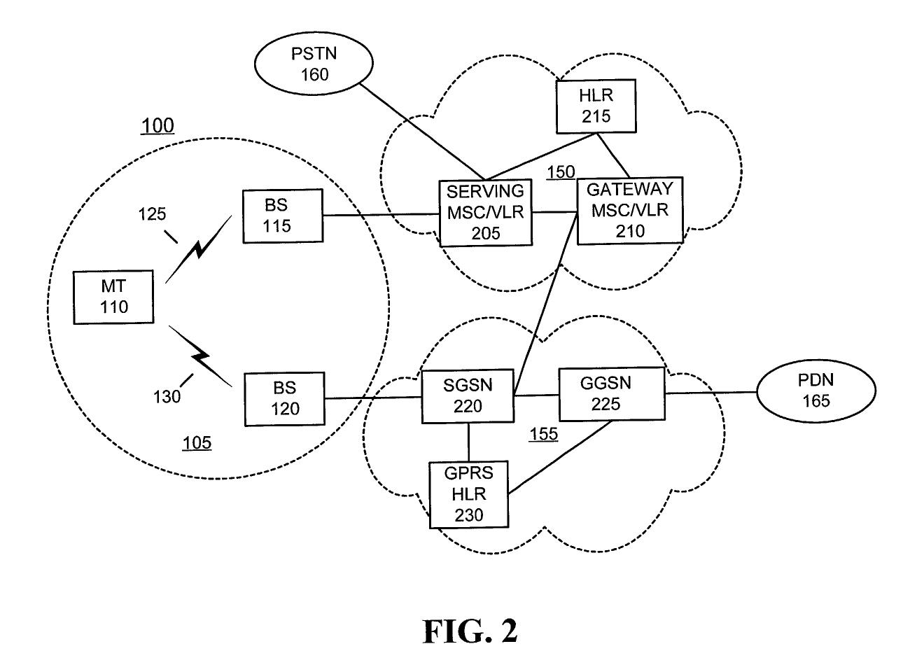

FIG. 2 illustrates exemplary details of the first radio communications cell 105 interconnected with circuit-switched network 150 and packet-switched network 155 for providing circuit-switched services on, for example, 30 kHz air interface 125 and for providing packet-switched services on, for example, 200 kHz air interface 130. As shown in FIG. 2, base station 115 may be interconnected with circuit-switched network 150 and base station 120 may be interconnected with packet-switched network 155. Circuit-switched network 150 may include a serving mobile switching center (MSC)/visitor location register (VLR) 205, a gateway MSC/VLR 210, and a home location register (HLR) 215. Packet-switched network 155 may include a Serving General Packet Radio Service (GPRS) Serving Node (SGSN) 220, a Gateway GPRS Serving Node (GGSN) 225, and a GPRS HLR 230.

Serving MSC/VLR 205 may include circuitry for controlling circuit calls to/from the mobile terminal 110 and other devices and for connecting those calls to the PSTN 160. Gateway MSC/VLR 210 may control circuit-related signaling to/from the mobile terminal 110 during those periods when mobile terminal 110 is camped on a packet channel. Gateway MSC/VLR 205 tunnels this signaling to the mobile terminal 110 in a well-known manner through SGSN 220. Tunneling involves, for example, the use of circuit-switched protocols on a packet control channel. HLR 215 may include one or more databases that store and manage subscriber data for a subscriber's circuit-switched services. Upon interrogation by the serving MSC/VLR 205, HLR 215 provides routing information for the indicated subscriber.

SGSN 220 may include circuitry for controlling packet data sessions between the mobile terminal 110 and other devices. SGSN 220 may connect those sessions to the GGSN 225. The GPRS HLR 230 may include one or more databases that store and manage subscriber data for a subscriber's packet data services. Upon interrogation by SGSN 220, GPRS HLR 230 may provide packet data subscription-related information. Upon interrogation by the GGSN 225, GPRS HLR 230 may provide routing information for the indicated subscriber. GGSN 225 may include circuitry for connecting packet data sessions between the mobile terminal 110 and PDN 165.

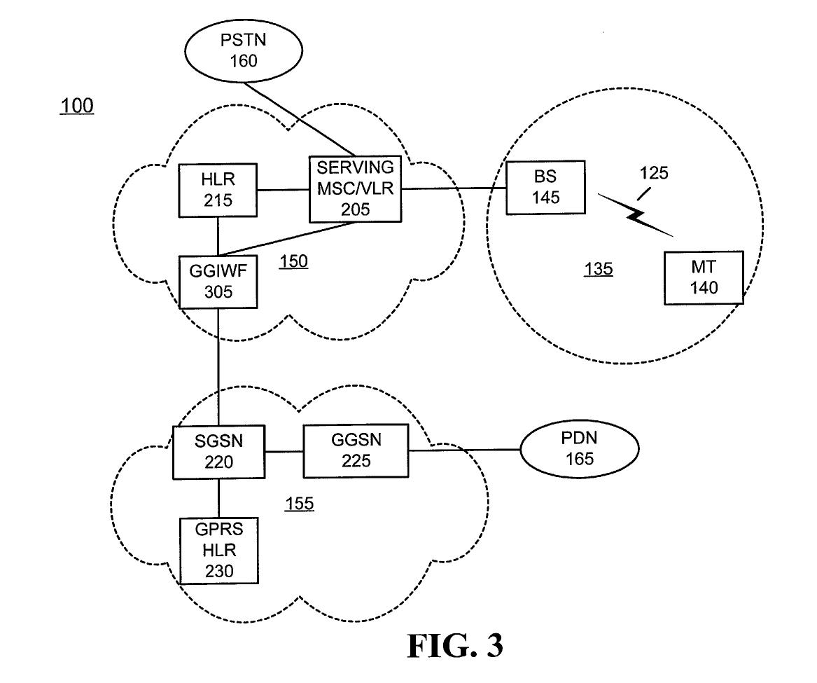

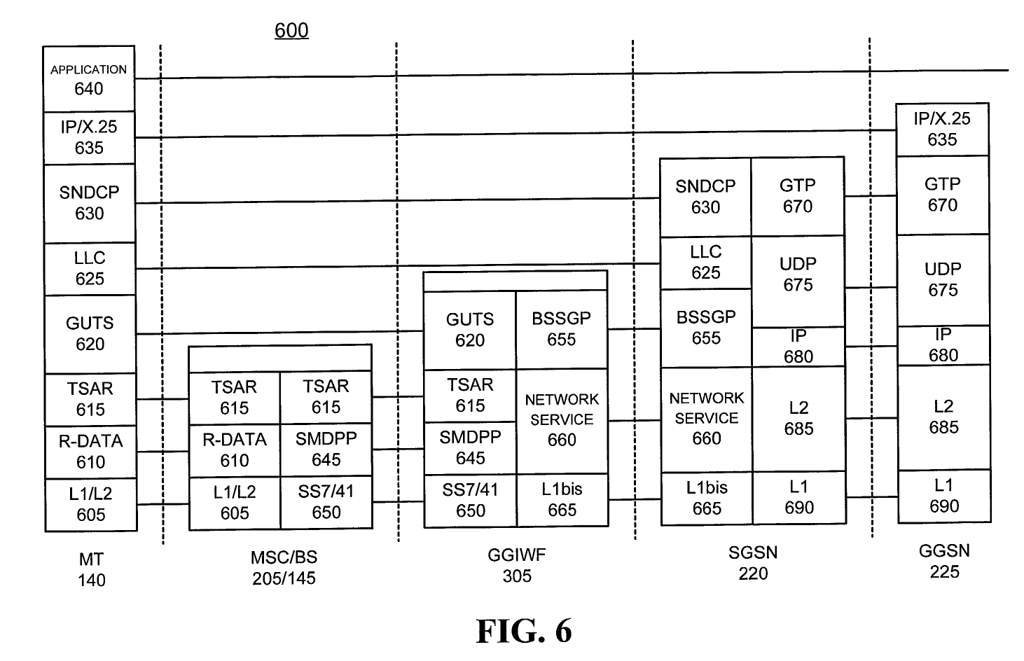

FIG. 3 illustrates exemplary details of the second radio communications cell 135, interconnected with circuit-switched network 150 and packet-switched network 155, for providing circuit-switched services or packet-switched services on air interface 125. As shown in FIG. 3, base station 145 may be interconnected with circuit-switched network 150. Circuit-switched network 150 may include a serving MSC/VLR 205, a HLR 215, and a General UDP Transport Service (GUTS)/GPRS Internetworking Function (GGIWF) device 305. GGIWF 305 may include a GUTS teleservice server (GUTS TS) (as specified in TIA/EIA-136-750) that has been modified consistent with the present invention (see GGIWF protocol architecture in FIG. 6 below).

Packet-switched network 155 may include a Serving General Packet Radio Service (GPRS) Serving Node (SGSN) 220, a Gateway GPRS Serving Node (GGSN) 225, and a GPRS

Home Location Register (HLR) 230.

Serving MSC/VLR 205 may include circuitry for controlling circuit calls to/from the mobile terminal 140 and other devices and connects those calls to the PSTN 160. GGWIF 305 may control packet-data related services with mobile terminal 140 when mobile terminal 140 communicates with packet-switched network 155. HLR 215 may include one or more databases that store and manage subscriber data for a subscriber's circuit-switched services.

SGSN 220 may include circuitry for controlling packet data sessions between the mobile terminal 140 and other devices. SGSN 220 may connect those sessions to the GGSN 225. The GPRS HLR 230 may include one or more databases that store and manage subscriber data for a subscriber's packet data services. Upon interrogation by SGSN 220, GPRS HLR 230 may provide packet data subscription-related information. Upon interrogation by the GGSN 225, GPRS HLR 230 may provide routing information for the indicated subscriber. GGSN 225 may include circuitry for connecting packet data sessions between the mobile terminal 140 and PDN 165 via GGIWF 305.

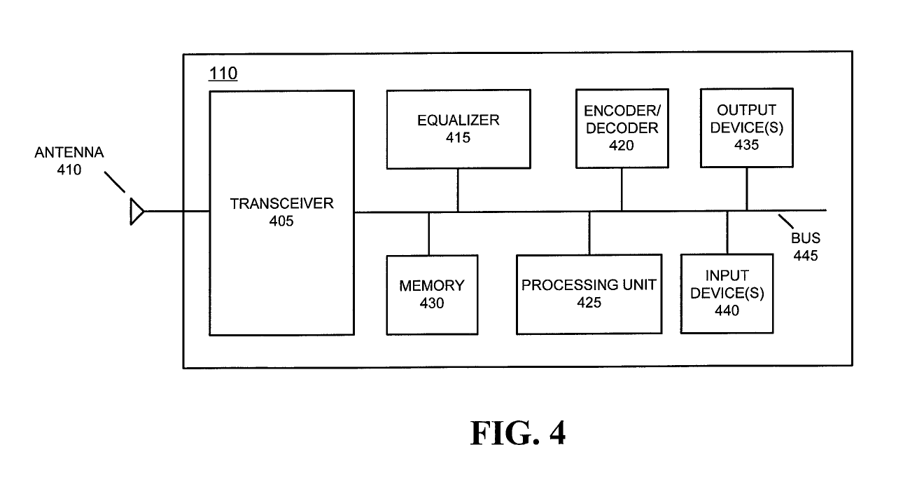

FIG. 4 illustrates an exemplary configuration of mobile terminal 110 consistent with the present invention. Mobile terminal 140 may be similarly configured. Mobile terminal 110 may include a transceiver 405, an antenna 410, an equalizer 415, an encoder/decoder 420, a processing unit 425, a memory 430, output device(s) 435, input device(s) 440, and a bus 445.

Transceiver 405 may connect mobile terminal 110 to another mobile terminal or network, such as network 150. For example, transceiver 405 may include transceiver circuitry well known to one skilled in the art for transmitting and/or receiving data bursts in a network, such as network 150, via antenna 410.

Equalizer 415 may store and implement conventional Viterbi trellises for estimating received symbol sequences using, for example, a conventional maximum likelihood sequence estimation technique. Equalizer 415 may additionally include conventional mechanisms for performing channel estimation. Encoder/decoder 420 may include conventional circuitry for decoding and/or encoding received or transmitted symbol sequences. Processing unit 425 may perform all data processing functions for inputting, outputting, and processing of data including data buffering and device control functions, such as call processing control, user interface control or the like.

Memory 430 may provide permanent, semi-permanent, or temporary working storage of data and instructions for use by processing unit 425 in performing processing functions. Memory 430 may include large-capacity storage devices, such as a magnetic and/or optical recording medium and its corresponding drive.

Output device(s) 435 may include conventional mechanisms for outputting data in video, audio, and/or hard copy format. Input device(s) 440 permit entry of data into mobile terminal 110 and may include a user interface and a microphone (not shown). The microphone can include conventional mechanisms for converting auditory input into electrical signals.

Bus 445 interconnects the various components of mobile terminal 110 to permit the components to communicate with one another.

The configuration of mobile terminal 110, shown in FIG. 4, is for provided for illustrative purposes only. One skilled in the art will recognize that other configurations may be employed. Moreover, one skilled in the art will appreciate that a typical mobile terminal 110 may include other devices that aid in the reception, transmission, or processing of data.

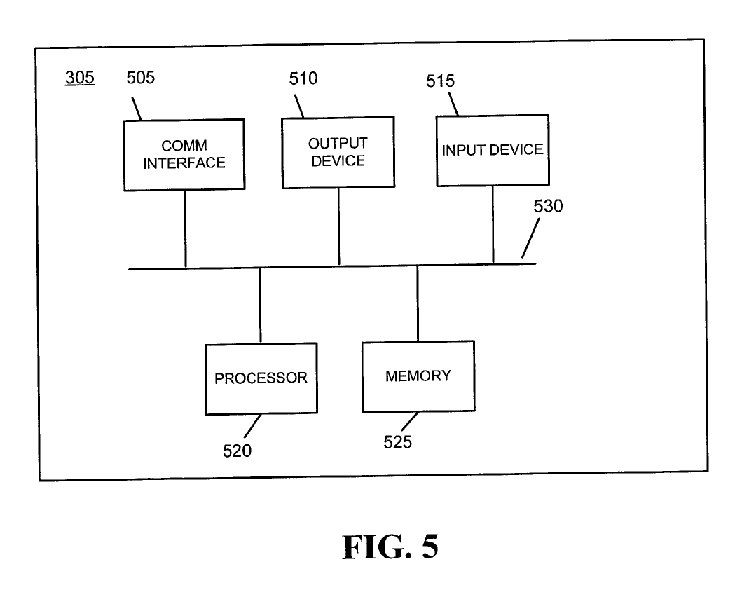

FIG. 5 illustrates an exemplary GGIWF 305 consistent with the present invention. GGIWF 305 may include a communication interface 505, an output device 510, an input device 515, a processor 520, a memory 525, and a bus 530. Communication interface 505 connects GGIWF 305 to another device or network, such as serving MSC/VLR 205, HLR 215 and SGSN 220. Output device 510 permits the output of GGIWF data in video, audio, or hard copy format and input device 515 permits entry of data into GGIWF 305.

Processor 520 performs all data processing functions for inputting, outputting, and processing of GGIWF data. Memory 525 may include Random Access Memory (RAM) that provides temporary working storage of data and instructions for use by processor 520 in performing processing functions. Memory 525 may additionally include Read Only Memory (ROM) that provides permanent or semi-permanent storage of data and instructions for use by processor 520. Memory 525 can include large-capacity storage devices, such as a magnetic and/or optical recording medium and its corresponding drive. Bus 530 interconnects the various components of GGIWF 305 and allows the components to communicate with one another.

FIG. 6 illustrates an exemplary protocol architecture 600 for providing GUTS/GPRS packet-data service (GGPS) consistent with the present invention. The protocol architecture 600 may include an L1/L2 layer 605, an R-Data layer 610, a Teleservice Segmentation and Reassembly (TSAR) layer 615, a GUTS layer 620, a Logic Link Control (LLC) layer 625, a Sub-Network Dependent Convergence Protocol (SNDCP) layer 630, an Internet Protocol (IP)/X.25 layer 635, an application layer 640, a Short Messaging Service (SMS) Delivery Point to Point (SMDPP) layer 645, an SS7/41 layer 650, a Base Station System GPRS Protocol (BSSGP) layer 655, a network service layer 660, a L1bis layer 665, a GPRS Tunnel Protocol (GTP) layer 670, a User Datagram Protocol (UDP) layer 675, an Internet Protocol (IP) layer 680, an L2 layer 685, and an L1 layer 690.

L1/L2 layer 605 may include a mechanism for physically transmitting data over the air interface 125, as well as error detection and correction information. R-Data Layer 610 may include protocol mechanisms for relaying teleservice data in a TDMA system. TSAR layer 615 may include conventional protocol mechanisms for segmenting and re-assembling packet data. GUTS layer 620 may include protocol mechanisms for delivering general purpose application data in a TDMA system. LLC layer 625 may include conventional protocol mechanisms for assuring the reliable transfer of user data from mobile terminal 140 to SGSN 220.

SNDCP layer 630 may include conventional protocol mechanisms for compressing and/or decompressing user data and protocol control information transmitted between mobile terminal 140 and SGSN 220. IP/X.25 layer 635 may act as a general purpose data routing layer. Application layer 640 may include any type of application protocol (e.g., TCP/FTP) that is used for data services. SMDPP layer 645 may include conventional protocol mechanisms for routing short message delivery point-to-point (SMDPP) messages. SS7/41 layer 650 may include several layers used to transport signaling in an ANSI-41 network. BSSGP layer 655 may include conventional mechanisms for conveying routing-related and Quality of Service (QOS) related information between GGIWF 305 and SGSN 220.

Network Service Layer 660 and L1bis layer 665 may include conventional mechanisms for transporting BSSGP Packet Data Units (PDUs) between GGIWF 305 and SGSN 220. GTP layer 670 may include conventional mechanisms for user transmitting data and control signaling between SGSN 220 and GGSN 225. UDP layer 675 may include conventional mechanisms to transport GTP PDUs for higher-layer protocols that do not need a reliable data link. UDP layer 675 may further include conventional mechanisms to protect against corrupted GTP PDUs.

IP layer 680 may include conventional protocol mechanisms for routing user data and control signaling. L2 layer 685 may include the link layer used for error detection and correction on the SGSN 220 to GGSN 225 interface. L1 layer 690 may include the physical layer that physically connects the SGSN 220 and the GGSN 225.

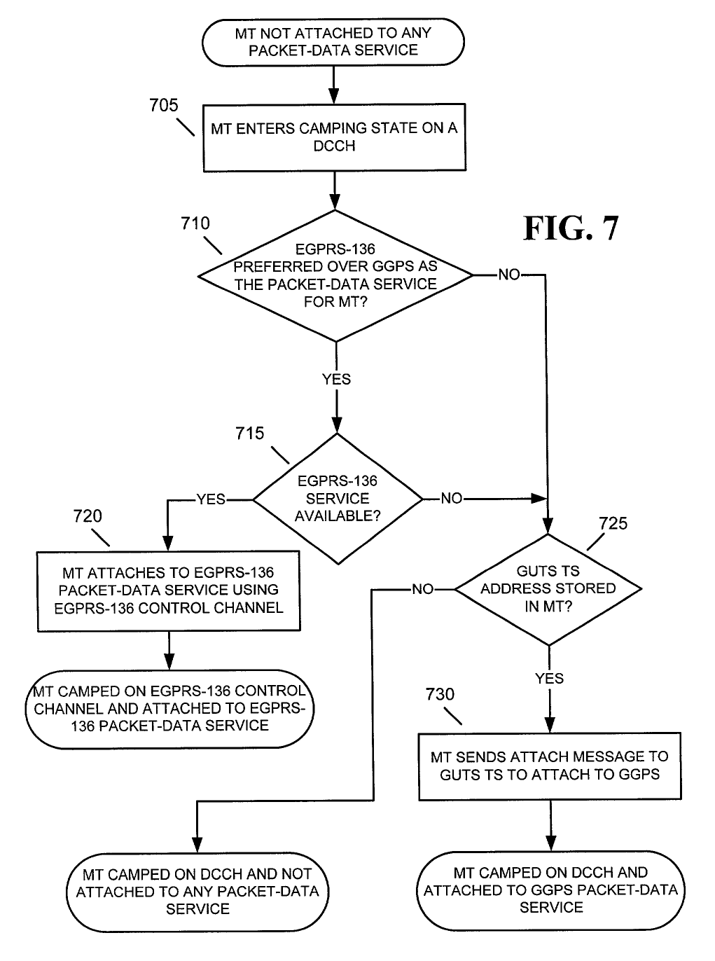

FIGS. 7-9 illustrate exemplary processing, consistent with the present invention, for implementing packet data service at mobile terminal 110 or 140. As one skilled in the art will appreciate, the method exemplified by FIGS. 7-9 may be implemented as a sequence of instructions and stored in a computer-readable medium, such as memory 430 of mobile terminal 110 or 140, for execution by processing unit 425. A computer-readable medium may include one or more memory devices and/or carrier waves. Alternatively, the process may be implemented in hardware or in any combination of hardware and software.

FIG. 7 illustrates exemplary processing, consistent with the present invention, for attempting to attach mobile terminal 110 or 140 to a packet-data service when the mobile terminal initially may not be attached to any packet-data service. To begin processing, mobile terminal 110 or 140 may enter a camping state on a digital control channel (DCCH) using conventional techniques [step 705]. Mobile terminal 110 may then determine if EGPRS-136 is preferred over GGPS as the packet-data service for the mobile terminal [step 710]. EGPRS-136 may, for example, be the preferred packet-data service when the mobile terminal's 110 or 140 communication session requires a higher bandwidth or quality of service. If EGPRS-136 is preferred over GGPS, mobile terminal 110 or 140 may determine if EGPRS-136 service is available in the radio communications cell in which the mobile terminal 110 is presently located (e.g., either radio-communications cell 105 or 135) [step 715]. If not, processing proceeds to step 725 below. If EGPRS-136 is available, then mobile terminal 110 or 140 may attach to EGPRS-136 packet-data service using an EGPRS-136 control channel in accordance with conventional techniques [step 720].

If, at step 710, mobile terminal 110 or 140 determines that GGPS is the preferred packet-data service, the mobile terminal may determine if a GUTS TS address is stored in the mobile terminal [step 725]. This address may be preprogrammed in the mobile terminal 110 or 140. Alternatively, the address may be delivered to the mobile terminal 110 or 140 via over-the-air programming (i.e., delivered via signaling to the mobile terminal 110 or 140). If a GUTS TS address is not stored in the mobile terminal, processing completes with mobile terminal 110 or 140 camped on the DCCH and not attached to any packet-data service. If a GUTS TS address is stored in mobile terminal 110 or 140, the mobile terminal may send an Attach message to the GUTS TS to attach to GGPS [step 730]. Processing, thus, completes at step 730 with the mobile terminal 110 or 140 camped on the DCCH and attached to the GGPS packet-data service.

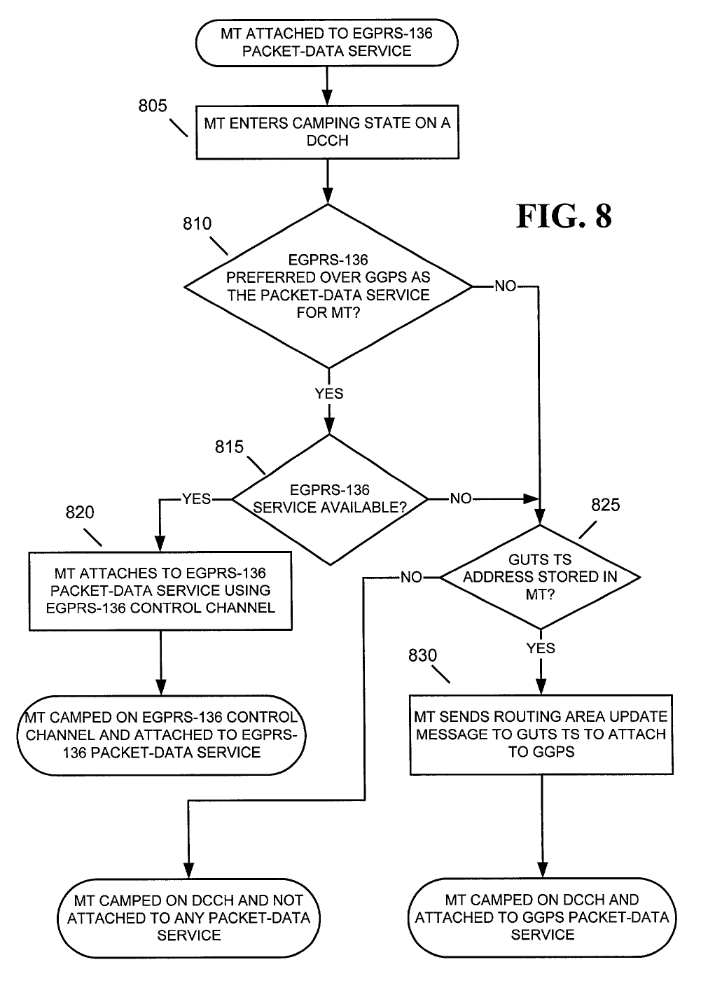

FIG. 8 illustrates exemplary processing, consistent with the present invention, for attempting to attach mobile terminal 110 or 140 to a packet-data service when the mobile terminals are initially attached to an EGPRS-136 packet-data service. To begin processing, mobile terminal 110 or 140 may perform a packet control channel reselection operation in which the mobile terminal 110 or 140 switches from one packet control channel to another. This reselection process may occur, for example, as a result of mobile terminal 110 or 140 being moved to a new location. Assume that mobile terminal 110 or 140 enters a camping state on a DCCH [step 805]. Mobile terminal 110 or 140 then may determine if EGPRS-136 is preferred over GGPS as the packet-data service for the mobile terminal [step 810]. EGPRS-136 may, for example, be the preferred packet-data service when the mobile terminal's 110 communication session requires a higher bandwidth or quality of service. If so, mobile terminal 110 or 140 determines if EGPR-136 service is available in the current radio communications cell [step 815]. If not, processing continues at step 825 below. If EGPRS-136 service is available, mobile terminal 110 or 140 attaches to the EGPRS-136 packet-data service using the EGRS-136 control channel in accordance with conventional techniques [step 820].

If, at step 810, mobile terminal 110 or 140 determines that GGPS is the preferred packet-data service, the mobile terminal may determine if a GUTS TS address is stored in memory 430 [step 825]. This address may be preprogrammed in the mobile terminal 110 or 140. If not, processing may complete with mobile terminal 110 or 140 camped on the DCCH and not attached to any packet-data service. If mobile terminal 110 or 140 determines that a GUTS TS address is stored in memory 430, the mobile terminal may send a routing area update message to the GUTS TS to attach to GGPS [step 830]. Processing, thus, completes at step 830, with mobile terminal 110 or 140 camped on the DCCH and attached to GGPS packet-data service.

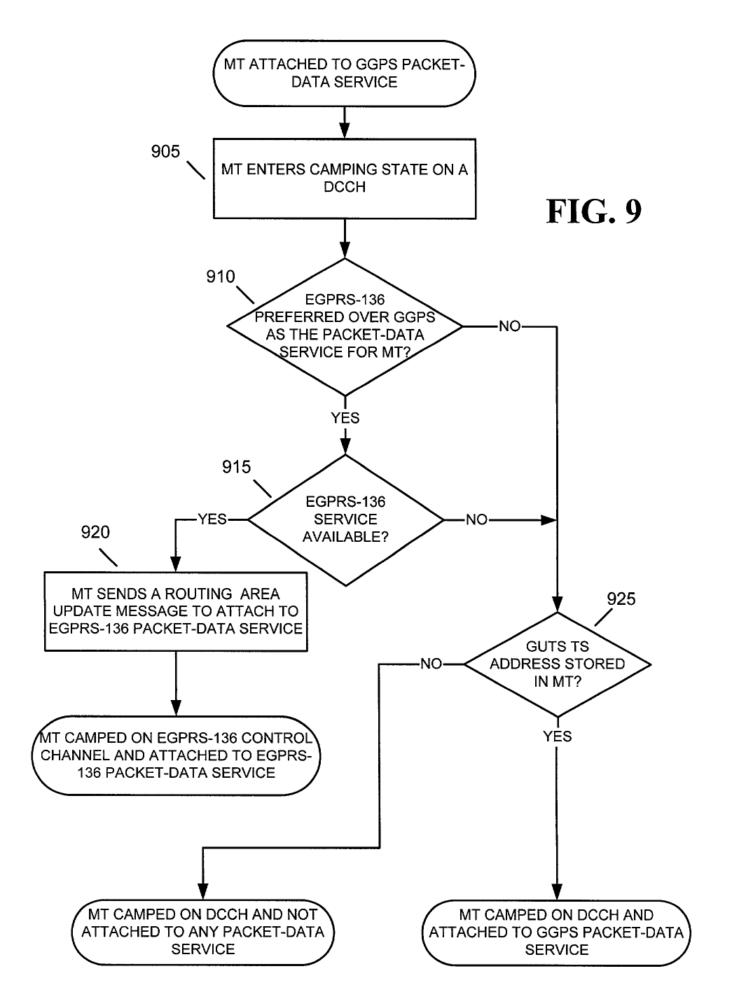

FIG. 9 illustrates exemplary processing, consistent with the present invention, for attempting to attach mobile terminal 110 or 140 to a packet-data service when the mobile terminal may be initially attached to the GGPS packet-data service. To begin processing, mobile terminal 110 or 140 enters a camping state on a DCCH [step 905]. Mobile terminal 110 or 140 then may determine if EGPRS-136 is preferred over GGPS as the packet-data service for the mobile terminal [step 910]. If so, mobile terminal 110 or 140 determines if EGPR-136 service is available in the current radio communications cell [step 915]. If not, processing continues at step 925 below. If EGPRS-136 service is available, mobile terminal 110 or 140 may send a routing area update message to attach to the EGPRS-136 packet-data service [step 920].

If, at step 910, mobile terminal 110 or 140 determines that GGPS is the preferred packet-data service, the mobile terminal may determine if a GUTS TS address is stored in memory 430 [step 825]. If not, processing may complete with mobile terminal 110 or 140 camped on the DCCH and not attached to any packet-data service. If mobile terminal 110 or 140 determines that a GUTS TS address is stored in memory 430, processing may complete with the mobile terminal camped on the DCCH and attached to the GGPS packet-data service.

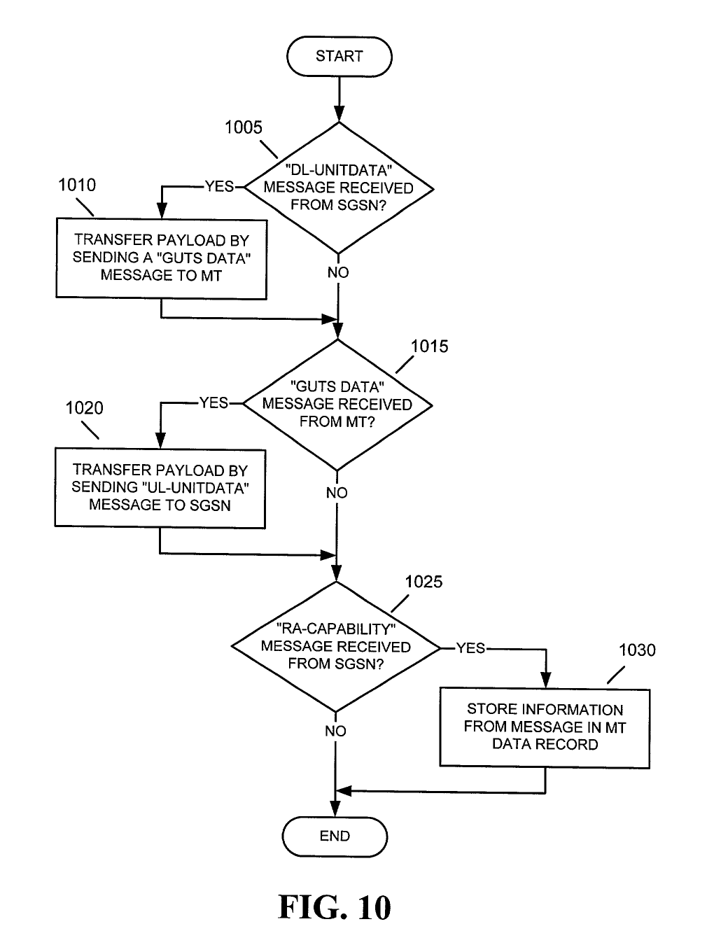

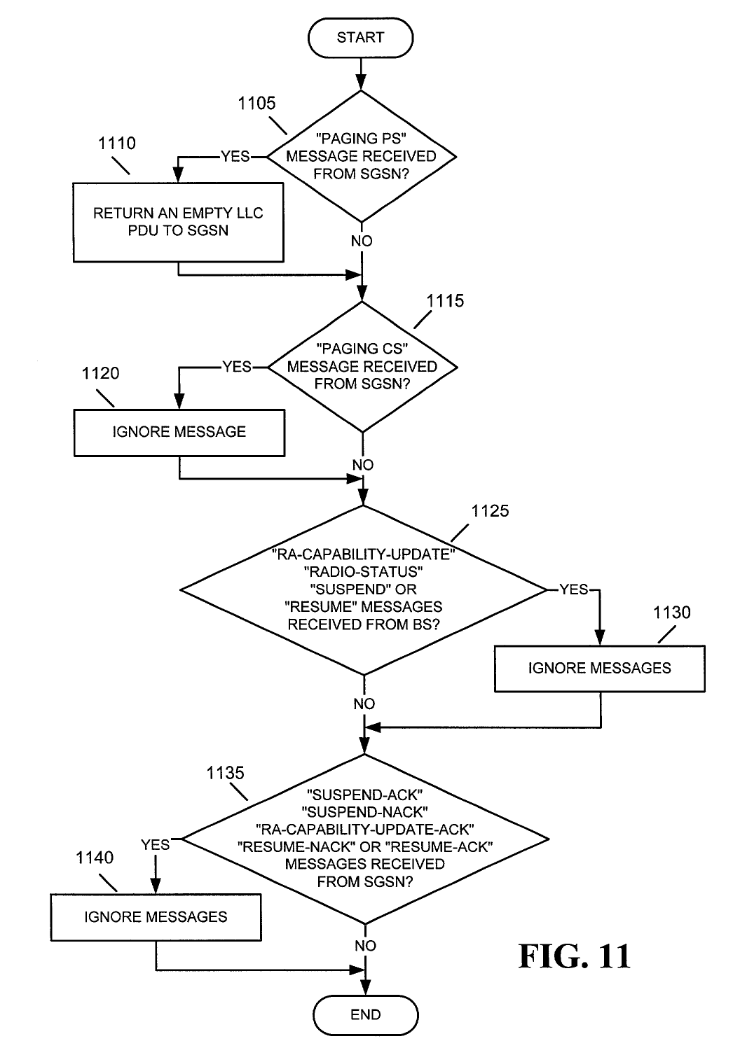

FIGS. 10-11 illustrate exemplary processing, consistent with the present invention, for processing messages received at GGIWF 305 from either BS 145 or SGSN 220. As one skilled in the art will appreciate, the method exemplified by FIGS. 10-11 may be implemented as a sequence of instructions and stored in a computer-readable medium, such as memory 525 of GGIWF 305, for execution by processor 520. A computer-readable medium may include one or more memory devices and/or carrier waves. Alternatively, the process may be implemented in hardware or in any combination of hardware and software.

FIG. 10 illustrates exemplary processing, consistent with the present invention, for processing BSSGP relay messages received at GGIWF 305. GGIWF 305 may determine if a conventional “DL-UNITDATA” message has been received from SGSN 220 [step 1005]. If so, GGIWF 305 may transfer the payload of the message by sending a conventional “GUTS DATA” message to mobile terminal 140 [step 1010]. If the “DL-UNITDATA” message has not been received, then GGIWF 305 may determine if a conventional “GUTS DATA” message has been received from mobile terminal 140 [step 1015]. If so, GGIWF 305 transfers the payload of the message by sending a conventional “UL-UNITDATA” message to SGSN 220 [step 1020]. If the “GUTS DATA” message has not been received, then GGIWF 305 determines if a conventional “RA-CAPABILITY” message has been received from SGSN 220 [step 1025]. If so, GGIWF 305 may store information from the received “RA-CAPABILITY” message in a data record in memory 525 associated with mobile terminal 140 [step 1030].

FIG. 11 illustrates exemplary processing, consistent with the present invention, for processing BSSGP GPRS Mobility Management (GMM) messages at GGIWF 305. GGIWF 305 may determine if a conventional “PAGING PS” message has been received from SGSN 220 [step 1105]. If so, GGIWF 305 can return an empty LLC PDU to SGSN 220 [step 1110]. If not, GGIWF 305 may determine if a conventional “PAGING CS” message has been received from SGSN 220 [step 1115]. If so, GGIWF 305 ignores the received “PAGING CS” message [step 1120]. If not, GGIWF 305 may determine if any of the following conventional messages have been received from BS 145 [step 1125]:

RA-CAPABILITY-UPDATE,

RADIO-STATUS,

SUSPEND, or

RESUME.

If so, GGIWF 305 ignores the messages. If not, GGIWF 305 may determine if any of the following conventional messages have been received from SGSN 220 [step 1135]:

SUSPEND-ACK,

SUSPEND-NACK,

RESUME-ACK,

RA-CAPABILITY-UPDATE-ACK, or

RESUME-NACK.

If so, GGIWF 305 ignores the received messages [step 1140]. If any of the messages have not been received, processing completes.

The foregoing description of preferred embodiments of the present invention provides illustration and description, but is not intended to be exhaustive or to limit the invention to the precise form disclosed. Modifications and variations are possible in light of the above teachings or may be acquired from practice of the invention. For example, the described implementation includes software and hardware, but elements of the present invention may be implemented as a combination of hardware and software, in software alone, or in hardware alone. Also, while series of steps have been described with regard to FIGS. 7-11, the order of the steps may be varied in other implementations consistent with the present invention. No element, step, or instruction used in the description of the present application should be construed as critical or essential to the invention unless explicitly described as such.

The present invention may be embodied as cellular communication systems, methods, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may include any medium that can contain, store, communicate, propagate, or transport the program for use by, or in connection with, the instruction execution system, apparatus, or device. The computer-usable or computer-readable medium may include, for example, but not limited to, an electronic, magnetic, optical, electromagnetic, infrared, or semiconductor system, apparatus, device, or propagation medium.

More specific examples (a non-exhaustive list) of a computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Additionally, the present invention is described herein, at least in part, in the context of EGPRS-136 or GPRS cellular communications system. While the present invention may be particularly useful for improving the performance of EGPRS-136 or GPRS cellular networks, it should be understood that the principles of the present invention may be applied to any cellular or wireless system utilizing other air interfaces. It should be further understood that the principles of the present invention may be utilized in hybrid systems that are combinations of two or more conventional air interfaces. In addition, a mobile terminal, in accordance with the present invention, may be designed to communicate with a base station transceiver using any standard based on GSM, TDMA, CDMA, FDMA, a hybrid of such standards or any other standard.

The scope of the invention is defined by the claims and their equivalents.

What is claimed is:

1. A method of implementing packet data service at a mobile terminal in a radio-communications network, comprising:
sending or receiving data packets via a first packet data service over a first radio-communications channel comprising a first bandwidth; and
sending or receiving data packets via a second packet data service over a second radio-communications channel comprising a second bandwidth, the second radio-communications channel being a circuit-switched control channel.

2. The method of claim 1, wherein the first packet data service comprises an EGPRS-136 packet data service.

3. The method of claim 1, wherein the first packet data service comprises a GPRS packet data service.

4. The method of claim 1, wherein the first bandwidth comprises a 200 kHz bandwidth.

5. The method of claim 4, wherein the second bandwidth comprises a 30 kHz bandwidth.

6. The method of claim 1, wherein the second packet data service comprises a General UDP Transport Service(GUTS)/General Packet Radio Service (GPRS) packet data service.

7. A mobile terminal, comprising:
first transceiver circuitry that:
sends or receives data packets via a first packet data service over a first radio-communications channel comprising a first bandwidth; and
second transceiver circuitry that:
sends or receives data packets via a second packet data service over a second radio-communications channel comprising a second bandwidth, the second radio-communications channel being a circuit-switched control channel.

8. The mobile terminal of claim 7, wherein the first packet data service comprises an EGPRS-136 packet data service.

9. The mobile terminal of claim 7, wherein the first packet data service comprises a GPRS packet data service.

10. The mobile terminal of claim 6, wherein the first bandwidth comprises a 200 kHz bandwidth.

11. The mobile terminal of claim 10, wherein the second bandwidth comprises a 30 kHz bandwidth.

12. The mobile terminal of claim 7, wherein the second packet data service comprises a General UDP Transport Service(GUTS)/GPRS packet data service.

13. A method of implementing packet data service at a mobile terminal in a radio-communications network, comprising:
determining a preference between a first packet data service and a second packet data service;
determining, if the first packet data service is preferred, whether the first packet data service is available;
attaching to the first packet data service if the first packet data service is available; and
attaching to the second packet data service if the first packet data service is unavailable.

14. The method of claim 13, wherein the first packet data service comprises an EGPRS-136 packet data service.

15. The method of claim 13, wherein the first packet data service comprises a GPRS packet data service.

16. The method of claim 13, wherein the second packet data service comprises a General UDP Transport Service(GUTS)/GPRS packet data service.

17. The method of claim 13, wherein the attaching to the first packet data service further comprises:
using a EGPRS-136 control channel to attach to the first packet data service.

18. The method of claim 13, wherein the attaching to the first packet data service further comprises:
using a routing area update message to attach to the first packet data service.

19. The method of claim 13, wherein the attaching to the second packet data service further comprises:
using a routing area update message to attach to the second packet data service.

20. The method of claim 13, wherein the attaching to the second packet data service further comprises:
using an attach message to attach to the second packet data service.

21. A mobile terminal, comprising:
a memory that stores instructions; and
a processing unit that executes the instructions to:
determine a preference between a first packet data service and a second packet data service,
determine, if the first packet data service is preferred, whether the first packet data service is available,
initiate attachment to the first packet data service if the first packet data service is available, and
initiate attachment to the second packet data service if the first packet data service is unavailable.

22. The mobile terminal of claim 21, wherein the first packet data service comprises an EGPRS-136 packet data service.

23. The mobile terminal of claim 21, wherein the second packet data service comprises a General UDP Transport Service(GUTS)/GPRS packet data service.

24. The mobile terminal of claim 21, further comprising:
a transceiver that uses a EGPRS-136 control channel to attach to the first packet data service.

25. The mobile terminal of claim 21, further comprising:
a transceiver that transmits a routing area update message to attach to the first packet data service.

26. The mobile terminal of claim 21, further comprising:
a transceiver that transmits a routing area update message to attach to the second packet data service.

27. A method of servicing packet data in a radio-communication system, comprising:
receiving first packets over a first radio-communications channel comprising a first bandwidth;
forwarding the first packets, via a first path, to a packet-switched network;
receiving second packets over a second radio-communications channel comprising a second bandwidth, the second radio-communications channel being a circuit-switched control channel; and
forwarding the second packets, via a second path, to the packet-switched network.

28. The method of claim 27, wherein the first bandwidth comprises a 200 kHz bandwidth.

29. The method of claim 27, wherein the second bandwidth comprises a 30 kHz bandwidth.

30. The method of claim 27, wherein the second path comprises a mobile switching center.

31. The method of claim 30, wherein the second path further comprises a General UDP Transport Service (GUTS) teleservice server.

32. The method of claim 27, wherein the first path comprises a Serving General Packet Radio Service Serving Node.

33. A radio-communications system, comprising:
a mobile terminal that:
transmits first packets over a first radio-communications channel comprising a first bandwidth, and
transmits second packets over a second radio-communications channel comprising a second bandwidth, the second radio-communications channel being a circuit-switched control channel;
a first base station that:
receives and forwards the first packets, via a first path, to a packet-switched network; and
a second base station that:
receives and forwards the second packets, via a second path, to the packet-switched network.

34. The system of claim 33, wherein the first bandwidth comprises a 200 kHz bandwidth.

35. The system of claim 33, wherein the second bandwidth comprises a 30 kHz bandwidth.

36. The system of claim 33, wherein the second path comprises a mobile switching center.

37. The system of claim 36, wherein the second path further comprises a General UDP Transport Service(GUTS) teleservice server.

38. The system of claim 33, wherein the first path comprises a Serving General Packet Radio Service Serving Node.

39. A server, comprising:
a communication interface that receives packets transmitted from a mobile terminal using a packet-data service; and
a processing unit that processes the received packets for transmission to a Serving General Packet Radio Service Serving Node (SGSN).

40. The server of claim 39, wherein server comprises a General User Datagram Protocol Transport Service (GUTS) teleservice server.

41. The server of claim 39, wherein the communication interface further transmits the processed packets to the SGSN.

42. The server of claim 41, wherein the communication interface uses a Base Station System GPRS Protocol (BSSGP) for transmitting the received packets to the SGSN.

43. The server of claim 39, wherein the communication interface receives the packets using a General User Datagram Protocol Transport Service (GUTS) protocol.

44. The server of claim 39, wherein the communication interface receives the packets from the mobile terminal via a mobile switching center.

45. A radio-communications network, comprising:
a mobile terminal;
a packet-switched network that selectively provides a 200 kHz packet data service to the mobile terminal; and
a circuit-switched network that selectively provides, in conjunction with the packet-switched network, a 30 kHz packet data service to the mobile terminal.

46. A method of providing packet data service to a mobile terminal in a radio-communications network, comprising:
providing a 30 kHz packet data service to the mobile terminal; and
selectively providing a 200 kHz packet data service to the mobile terminal based on quality of service requirements of the mobile terminal.
